(19) United States
(12) Patent Application Publication
(10) Pub. No.: US 2007/0023065 A1
(43) Pub. Date: Feb. 1, 2007

(54) Method of removing particles on an object, apparatus for performing the removing method, method of measuring particles on an object and apparatus for performing the measuring method

(75) Inventors: Sang-Yup Kim, Gyeonggi-do (KR); Sung-Soo Jang, Gyeonggi-do (KR); Guk-Pil Kim, Gyeonggi-do (KR)

Correspondence Address: FILDES & OUTLAND, P.C., 20916 MACK AVENUE, SUITE 2, GROSSE POINTE WOODS, MI, 48236, US

(73) Assignee: Komico Ltd.

(21) Appl. No.: 11/481,340

(22) Filed: Jul. 5, 2006

(30) Foreign Application Priority Data
Jul. 26, 2005 (KR) P2005-67824

(51) Int. Cl. B08B 6/00

(52) U.S. Cl. 134/1.2; 250/492.2

(57) ABSTRACT

In a method of removing particles on an object in accordance with one aspect of the present invention, air is injected into a space where the object is placed to remove foreign substances in the space. A first light is irradiated onto the object to remove charges in the object. A second light is irradiated onto the object to remove moisture droplets between the object and the particles. A third light is irradiated onto the object to remove static electricity between the object and the particles. The particles are then blown off from the object. Thus, an adhesion force between the particles and the object may be removed so that the particles may be readily blown off from the object.

### CROSS-REFERENCE TO RELATED APPLICATIONS

This application claims priority under 35 USC § 119 to Korean Patent Application No. 2005-67824, filed on Jul. 26, 2005, the contents of which are herein incorporated by reference in its entirety.

### BACKGROUND OF THE INVENTION

1. Field of the Invention

Example embodiments of the present invention relate to a method and an apparatus for removing particles on an object, and a method and an apparatus for measuring particles on an object using the same. More particularly, example embodiments of the present invention relate to a method of removing particles on an object, such as a substrate for a semiconductor device or a flat display device, an apparatus for performing the removing method, a method of measuring the number of particles on an object using the removing method, and an apparatus for performing the measuring method.

2. Description of the Related Art

Recently, as a semiconductor device or a flat display device has become highly integrated, contaminants such as particles, which have adverse effects on operations of the semiconductor device or the flat display device, have been strictly managed. Therefore, methods of effectively removing particles on a substrate for a semiconductor device or a flat display device have been proposed. Further, in order to check the efficiency of the particle removal, methods of measuring the number of particles have been proposed.

A detector for detecting particles on an object is disclosed in Korean Patent Laid-Open Publication No. 2003-34179. The detector includes a scanner having at least one opening, a particle counter for counting the number of particles that pass through the opening of the scanner, a pump for sucking the particles into the particle counter, and a controller for controlling a speed of the pump.

However, as a particle to be removed from an object has a diameter of no more than about 0.1 μm, the particles may not be effectively removed from the object using the conventional method, because a strong adhesion force between the particle having the diameter of no more than about 0.1 μm and a surface of the object exists.

Specifically, the strong adhesion force, such as a charge force caused by charges charged on the surface of the object, a capillary force caused by fine moisture droplets between the surface of the object and the particles, and an electrostatic force caused by static electricity formed between the surface of the object and the particles, exist between the minute particles and the object. Since the above-mentioned strong adhesion force exists between the minute particles and the object, the minute particles may not be readily removed from the object using the conventional method. As a result, the minute particles remain on the substrate of the semiconductor device or the flat display device so that the semiconductor device or the flat display device may malfunction due to the remaining particles.

### SUMMARY OF THE INVENTION

Example embodiments of the present invention provide a method of removing particles on an object that is capable of readily blowing off the particles from the object.

Example embodiments of the present invention also provide an apparatus for performing the above-mentioned removing method.

Example embodiments of the present invention still also provide a method of measuring particles on an object using the above-mentioned removing method.

Example embodiments of the present invention yet still also provide an apparatus for performing the above-mentioned measuring method.

In a method of removing particles on an object in accordance with one aspect of the present invention, an adhesion force between the particles and the object is removed using a light. The particles are then blown off from the object.

According to one example embodiment, before removing the adhesion force, air may be injected into a space where the object is placed to remove foreign substances, such as moisture droplets, in the space.

According to another example embodiment, removing the adhesion force may include irradiating a first light onto the object to remove charges in the object, irradiating a second light onto the object to remove moisture droplets between the object and the particles, and irradiating a third light onto the object to remove static electricity between the object and the particles.

According to still another example embodiment, blowing off the particles from the object may include injecting a gas onto the object.

In a method of measuring particles on an object in accordance with another aspect of the present invention, an adhesion force between the particles and the object is removed using a light. The particles are then blown off from the object. The number of the blown-off particles is counted using a counter.

According to one example embodiment, counting the number of the blown-off particles may include sucking the blown-off particles into the counter.

An apparatus for removing particles on an object in accordance with still another aspect of the present invention includes a light-irradiating unit for irradiating a light onto the object to remove an adhesion force between the object and the particles. A gas-injecting unit injects a gas onto the object to blow off the particles from the object.

According to one example embodiment, an air-injecting unit may inject air into a space where the object is placed to remove foreign substances, such as moisture droplets, in the space.

According to another example embodiment, the light-irradiating unit may include a first irradiator for irradiating a first light onto the object to remove charges in the object, a second irradiator for irradiating a second light onto the object to remove moisture droplets between the object and the particles, and a third irradiator for irradiating a third light onto the object to remove static electricity between the object and the particles.

An apparatus for measuring particles on an object in accordance with still another aspect of the present invention includes a light-irradiating unit for irradiating a light onto the object to remove an adhesion force between the object and the particles. A gas-injecting unit injects a gas onto the object to blow off the particles from the object. A counting unit counts the number of the blown-off particles. A suction unit sucks the blown-off particles into the counting unit.

According to the present invention, the adhesion force such as a charge force caused by the charges, a capillary force caused by the moisture droplets and an electrostatic force caused by the static electricity between the particles and the object is removed so that the particles may be readily blown off from the object. Therefore, the particles may be readily removed from the object.

### BRIEF DESCRIPTION OF THE DRAWINGS

The above and other features and advantages of the invention will become readily apparent by reference to the following detailed description when considered in conjunction with the accompanying drawings wherein:

FIG. 1 is a block diagram illustrating an apparatus for removing particles on an object in accordance with a first example embodiment of the present invention;

FIG. 2 is a flow chart illustrating a method of removing particles on an object using the apparatus in FIG. 1;

FIG. 3 is a block diagram illustrating an apparatus for measuring particles on an object in accordance with a second example embodiment of the present invention; and

FIG. 4 is a flow chart illustrating a method of measuring particles on an object using the apparatus in FIG. 3;

### DESCRIPTION OF THE EMBODIMENTS

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “includes” and/or “including” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Embodiment 1

Apparatus for Removing Particles on an Object

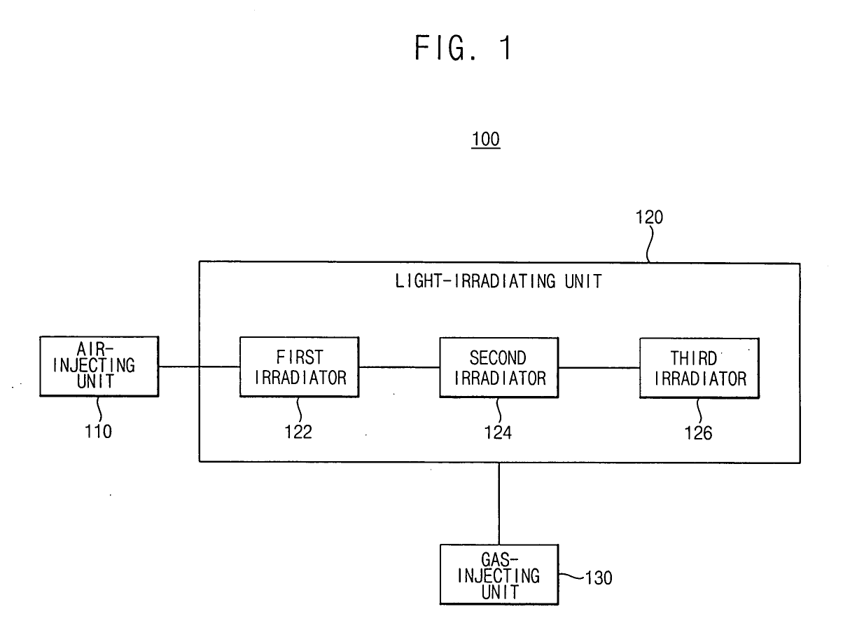

FIG. 1 is a block diagram illustrating an apparatus for removing particles on an object in accordance with a first example embodiment of the present invention.

Referring to FIG. 1, an apparatus 100 for removing particles on an object of this example embodiment includes an air-injecting unit 110, a light-irradiating unit 120 and a gas-injecting unit 130.

The air-injecting unit 110 injects filtered clean air onto the object on which the particles are stuck, such as a substrate for a semiconductor device or a flat display device, to remove foreign substances, such as moisture droplets, in a space where the object is positioned, such as a chamber. That is, to accurately measure the number of the particles on the object, the clean air injected from the air-injecting unit 110 blocks inflows of contaminants into the chamber, to control an environment in the chamber in advance.

The light-irradiating unit 120 removes an adhesion force such as a charge force, a moisture force, static electricity, etc., between the particles and the object. The light-irradiating unit 120 includes a first irradiator 122, a second irradiator 124, a third irradiator 126 or a combination thereof

The first irradiator 122 irradiates a first light onto the object to remove charges on a surface of the object. In this example embodiment, the first light may have a wavelength of about 100 nm to about 400 nm. An example of the first light having the above-mentioned wavelength may include an ultraviolet (UV) ray.

The second irradiator 124 irradiates a second light onto the object to remove moisture droplets between the particles and the object, and remaining particles that are not removed by the air. That is, since the moisture droplets between the particles and the object may generate a capillary force, the second light removes the moisture droplets so that the capillary force between the particles and the object is removed. In this example embodiment, the second light may have a wavelength of about 0.75 μm to about 1 mm. An example of the second light having the above-mentioned wavelength may include an infrared (IR) ray.

The third irradiator 126 irradiates a third light onto the object to remove static electricity between the object and the particles. In this example embodiment, the third light may have a wavelength of about 0.01 Å to about 10 Å. An example of the third light having the above-mentioned wavelength may include an X-ray.

The first to third lights irradiated from the first to third irradiator 122, 124 and 126, respectively, remove the adhesion force between the particles and the object. As a result, the particles may simply rest on the surface of the object, not adhered on the surface of the object.

The gas-injecting unit 130 injects a gas to the particles on the object to blow off the particles from the surface of the object. Since the particles simply rest on the surface of the object, the gas injected from the gas-injecting unit 130 may readily blow off the particles from the object. In this example embodiment, examples of the gas may include a nitrogen gas, an argon gas, a clean air, etc., having a density of no less than about 99.999%. Further, the gas may be injected at a speed of about 200 m/s to about 800 m/s.

Method of Removing Particles on an Object

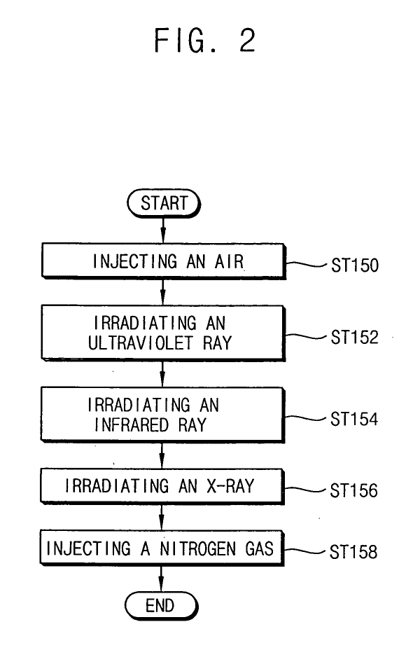

FIG. 2 is a flow chart illustrating a method of removing particles on an object using the apparatus in FIG. 1.

Referring to FIGS. 1 and 2, in step ST150, the air-injecting unit 110 injects the air into the chamber to remove foreign substances, such as the moisture droplets in the chamber. The air injected from the air-injecting unit 110 serves as to provide the chamber with a desired environment. After the desired environment is formed in the chamber, the object is loaded into the chamber.

In step ST152, the first irradiator 122 irradiates the first light having a wavelength of about 100 nm to about 400 nm onto the object to remove charges on the object.

In step ST154, the second irradiator 124 irradiates the second light having a wavelength of about 0.75 μm to about 1 mm onto the object to remove the moisture droplets between the object and the particles, thereby removing the capillary force between the object and the particles.

In step ST156, the third irradiator 126 irradiates the third light having a wavelength of about 0.01 Å to about 10 Å onto the object to remove the static electricity between the object and the particles.

Here, the first, second and third lights remove the adhesion force such as the charge force, the capillary force and the static electricity between the object and the particles. Thus, since the adhesion force does not exist between the particles and the object, the particles may simply rest on the surface of the object.

In step ST158, the gas-injecting unit 130 injects the gas such as the nitrogen gas, the argon gas, the clean air, etc., having a high density to blow off the particles from the surface of the object, thereby removing the particles from the object. Here, as described above, since the particles merely rest on the surface of the object, the injected gas may readily blow off the particles from the object.

According to this example embodiment, the adhesion force between the object and the particles may be removed using the first, second and third lights. Therefore, the particles may be readily blown off from the object so that efficiency for removing the particles may be remarkably improved.

Embodiment 2

Apparatus for Measuring Particles on an Object

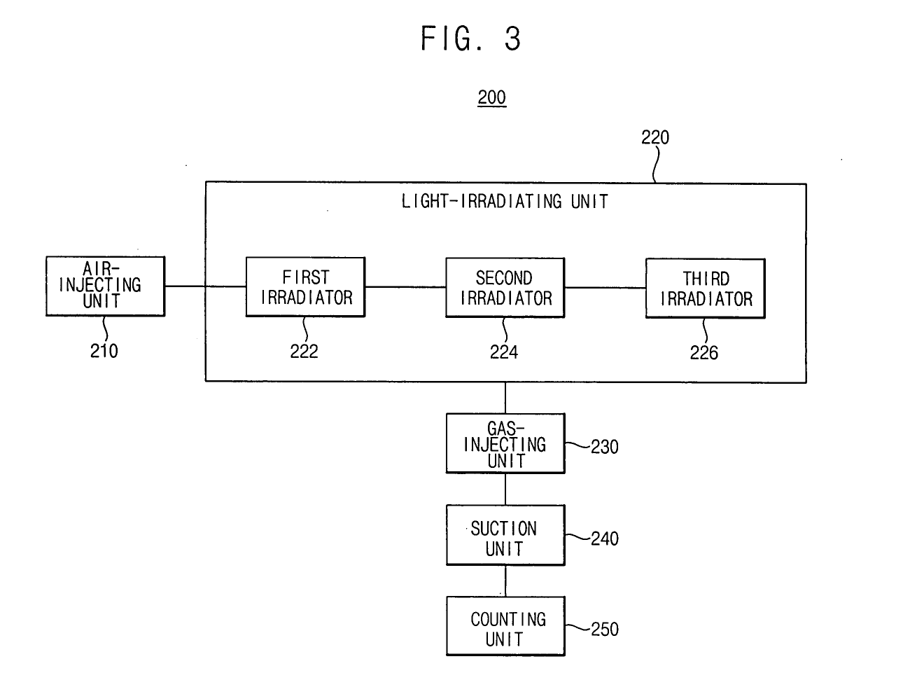

FIG. 3 is a block diagram illustrating an apparatus for measuring particles on an object in accordance with a second example embodiment of the present invention.

Referring to FIG. 3, an apparatus 200 for measuring particles on an object of this example embodiment includes an air-injecting unit 210, a light-irradiating unit 220, a gas-injecting unit 230, a suction unit 240 and a counting unit 250.

Here, the air-injecting unit 210, the light-irradiating unit 220, and the gas-injecting unit 230 are substantially the same as the air-injecting unit 110, the light-irradiating unit 120, and the gas-injecting unit 130 in Embodiment 1, respectively. Thus, any further illustrations with respect to the air-injecting unit 210, the light-irradiating unit 220, and the gas-injecting unit 230 are omitted herein for brevity.

The suction unit 240 sucks the particles blown off from the surface of the object by the gas-injecting unit 230 into the counting unit 250. In this example embodiment, the suction unit 240 may include a vacuum pump for providing a space over the object with vacuum.

The counting unit 250 counts the number of the particles sucked by the suction unit 240. Further, the counting unit 250 counts the number of initial particles that exit in the chamber into which the air is injected, and the number of the particles blown off by the gas-injecting unit 230 to obtain the number of particles remaining on the object. Efficiency for removing the particles may be accurately obtained based on the number of the remaining particles so that the apparatus 100 for removing the particles may be effectively managed.

Here, the counting unit 250 may include equipment referred to as a smart probe. In addition, a High-Efficiency Particulate Air (HEPA) filter (not shown), a pressure sensor (not shown), a particle detector (not shown), a particle filter (not shown) may be arranged between the counting unit 250 and the suction unit 240.

Method of Measuring Particles on an Object

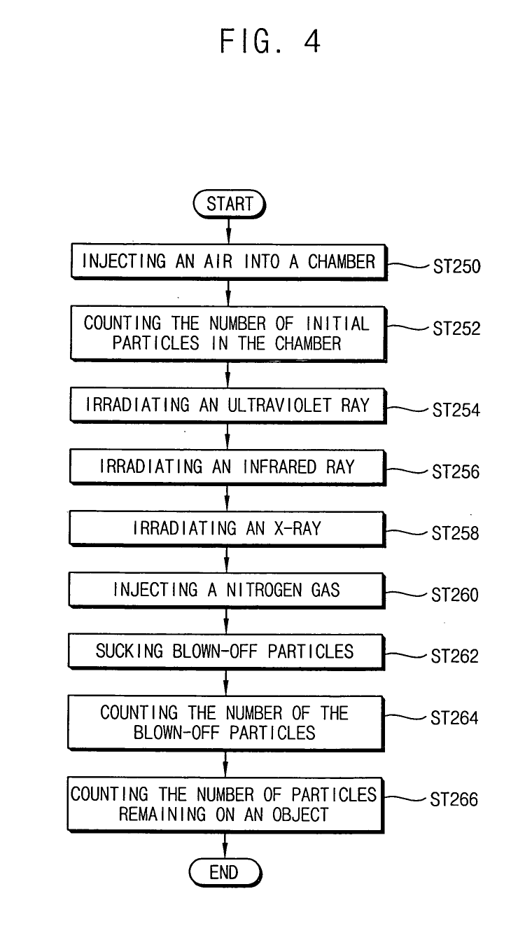

FIG. 4 is a flow chart illustrating a method of measuring particles on an object using the apparatus in FIG. 3.

Referring to FIGS. 3 and 4, in step ST250, the air-injecting unit 210 injects the air into the chamber to remove the foreign substances, such as the moisture droplets in the chamber.

In step ST252, the counting unit 250 counts the number of the initial particles in the chamber. The object is then loaded into the chamber.

In step ST254, the first irradiator 222 irradiates the UV ray having a wavelength of about 100 nm to about 400 nm onto the object to remove charges on the object.

In step ST256, the second irradiator 224 irradiates the IR ray having a wavelength of about 0.75 μm to about 1 mm onto the object to remove the moisture droplets between the object and the particles, thereby removing the capillary force between the object and the particles.

In step ST258, the third irradiator 226 irradiates an X-ray having a wavelength of about 0.01 Å to about 10 Å onto the object to remove the static electricity between the object and the particles.

In step ST260, the gas-injecting unit 230 injects the gas such as the nitrogen gas, the argon gas, the clean air, etc., having a high density to blow off the particles from the surface of the object.

In step ST262, the suction unit 240 provides the blown-off particles with the vacuum to suck the blown-off particles into the counting unit 250.

In step ST264, the counting unit 250 counts the number of the sucked particles.

In step ST266, the counting unit 250 subtracts the number of the sucked particles from the number of the initial particles to obtain the number of the particles remaining on the object. As a result, the efficiency for removing the particles may be obtained based on the number of the remaining particles and the number of the initial particles.

According to this example embodiment, the number of the initial particles and the number of the blown-off particles are measured so that the number of the particles remaining on the object after performing the removal of the particles may be accurately obtained. Thus, since the efficiency for removing the particles may be accurately obtained, the apparatus for measuring the particles may be effectively managed.

Here, in this example embodiment, the object includes the substrate for the semiconductor device or the flat display device. However, it is obvious to persons skilled in the art that the object is not restricted to the substrate. That is, the methods and the apparatuses of the present invention may be employed in removing particles from other objects.

According to the present invention, the adhesion force between the particles and the object is removed using the light so that the particles may be readily blown off from the object. As a result, the efficiency for removing the minute particles may be remarkably improved.

Having described the preferred embodiments of the present invention, it is noted that modifications and variations can be made by persons skilled in the art in light of the above teachings. It is therefore to be understood that changes may be made in the particular embodiment of the present invention disclosed which is within the scope and the spirit of the invention outlined by the appended claims.

What is claimed is:

1. A method of removing particles on an object, comprising:
removing an adhesion force between the object and the particles using a light; and
blowing off the particles from the object.

2. The method of claim 1, before removing the adhesion force, further comprising injecting air into a space where the object is placed to remove foreign substances in the space.

3. The method of claim 1, wherein removing the adhesion force comprises:
irradiating a first light onto the object to remove charges in the object;
irradiating a second light onto the object to remove moisture droplets between the object and the particles; and
irradiating a third light onto the object to remove static electricity between the object and the particles.

4. The method of claim 3, wherein the first light comprises an ultraviolet ray, the second light comprises an infrared ray, and the third light comprises an X-ray.

5. The method of claim 1, wherein blowing off the particles from the object comprises injecting a gas onto the object.

6. The method of claim 5, wherein the gas comprises a nitrogen gas, an argon gas or a clean air, and the gas is injected at a speed of about 200 m/s to about 800 m/s.

7. The method of claim 1, wherein the object comprises a substrate for a semiconductor device or a flat display device.

8. A method of measuring particles on an object, comprising:
removing an adhesion force between the object and the particles using a light;
blowing off the particles from the object; and
counting the number of the blown-off particles using a counting unit.

9. The method of claim 8, before removing the adhesion force, further comprising injecting air into a space where the object is placed to remove foreign substances in the space.

10. The method of claim 8, wherein removing the adhesion force comprises:
irradiating a first light onto the object to remove charges in the object;
irradiating a second light onto the object to remove moisture droplets between the object and the particles; and
irradiating a third light onto the object to remove static electricity between the object and the particles.

11. The method of claim 8, wherein blowing off the particles from the object comprises injecting a gas onto the object.

12. The method of claim 8, wherein counting the particles comprises sucking the blown-off particles into the counting unit.

13. The method of claim 8, further comprising:
counting the number of initial particles in a space where the object is placed before removing the adhesion force; and
obtaining the number of particles remaining on the object based on the number of the initial particles and the number of the blown-off particles.

14. An apparatus for removing particles on an object, comprising:
a light-irradiating unit for irradiating a light onto the object to remove an adhesion force between the object and the particles; and
a gas-injecting unit for injecting a gas onto the object to blow off the particles from the object.

15. The apparatus of claim 14, further comprising an air-injecting unit for injecting air into a space where the object is placed to remove foreign substances in the space.

16. The apparatus of claim 14, wherein the light-irradiating unit comprises:
a first irradiator for irradiating a first light onto the object to remove charges in the object;
a second irradiator for irradiating a second light onto the object to remove moisture droplets between the object and the particles; and
a third irradiator for irradiating a third light onto the object to remove static electricity between the object and the particles.

17. The apparatus of claim 16, wherein the first light comprises an ultraviolet ray, the second light comprises an infrared ray, and the third light comprises an X-ray.

18. The apparatus of claim 14, wherein the gas comprises a nitrogen gas, an argon gas or a clean air.

19. An apparatus for measuring particles on an object, comprising:
a light-irradiating unit for irradiating a light onto the object to remove an adhesion force between the object and the particles;
a gas-injecting unit for injecting a gas onto the object to blow off the particles from the object;
a counting unit for counting the number of the blown-off particles; and
a suction unit for sucking the blown-off particles into the counting unit.

20. The apparatus of claim 19, wherein counting unit counts the number of initial particles in the space to obtain the number of particles remaining on the object based on the number of the initial particles and the number of the blown-off particles.
